(19) United States
(12) Patent Application Publication
(10) Pub. No.: US 2010/0270872 A1
(43) Pub. Date: Oct. 28, 2010

(54) BEARING DEVICE FOR ROTARY MOTOR

(76) Inventors: Masayuki Yokoyama, Tokyo (JP); Youichi Fujita, Tokyo (JP); Sotsuo Miyoshi, Tokyo (JP)

Correspondence Address: BIRCH STEWART KOLASCH & BIRCH, PO BOX 747, FALLS CHURCH, VA, 22040-0747, US

(21) Appl. No.: 12/682,540

(22) PCT Filed: Sep. 8, 2008
(86) PCT No.: PCT/JP2008/002469

§ 371 Date: Apr. 9, 2010

(30) Foreign Application Priority Data
Dec. 27, 2007 (JP) 2007-335876

(51) Int. Cl. H02K 5/16; H02K 5/02

(52) U.S. Cl. 310/43; 310/425

(57) ABSTRACT

A bearing device for a rotary motor 1 includes a stator 20 having provided thereon a coil 22 to which a current is fed; a rotor 30 rotating the inside of the stator 20 and having a rotor magnet 32; a motor shaft 33 having a screw portion meshing with a threaded aperture 31a provided within the rotor 30; a bearing support member 40 having a bearing 41 for the motor shaft 33 and molded of a thermoplastic resin; and a bearing side case 50 for housing the bearing support member 40 and molded of a thermoplastic resin, wherein an insert nut 46 is installed across the bearing side case and bearing support member to be united through outsert-molding.

### TECHNICAL FIELD

The present invention relates to a bearing device for a rotary motor, and more particularly to a fixing structure of a bearing device.

### BACKGROUND ART

Conventionally, for apparatuses driving a shaft by a rotary motor, there is an apparatus disclosed in, for example, Patent Document 1 or Patent Document 2. One example of a bearing device for a rotary motor of the foregoing type is shown in FIG. 4 and FIG. 5. FIG. 4 is a view showing a composition of a conventional bearing device for a rotary motor, and FIG. 5 is an enlarged view showing a fixing structure of a bearing support member. First, a bearing side case 50 is provided with a pilot hole 91 smaller than the outer diameter of a tapping screw 90. A bearing support member 40 and a board 47 are provided with screw passing holes 92 and 93, respectively, to be insertable by the tapping screw 90. Then, the tapping screw 90 is passed through those screw passing holes 92 and 93, and also the tapping screw 90 is screwed into the pilot hole 91, to thereby secure the bearing support member 40 and board 47 to the bearing side case 50.

Since the conventional bearing device for a rotary motor is arranged as described above, the bearing support member is fixed to the bearing side case by the axial force of the tapping screw. For this reason, there is a problem that in the event where a creep phenomenon occurs in the resin forming the bearing support member and bearing side case in high temperature environments, the resin around the tapping screw and also the resin surrounding the screw passing hole get fatigued to greatly reduce the fastening strength of the bearing support member. Further, there is a problem that when loads caused by the rotation of the motor and external vibrations are imposed on the bearing of the bearing support member under the condition where the fastening strength of the bearing support member is reduced, the bearing support member is wobbled to occur wear thereof; as the wear is promoted, the vibration of the rotor is accelerated to damage every section or part and come into an inoperative state of the motor.

The present invention has been made to solve the above-mentioned problems, and an object of the present invention is to provide a bearing device for a rotary motor that can ensure the securing strength of a bearing support member even in high temperature environments.

### DISCLOSURE OF THE INVENTION

The bearing device for a rotary motor according to the present invention includes a stator having provided thereon a coil to which a current is fed; a rotor rotating the inside of the stator and having a magnet; an output shaft having a screw portion meshing with a threaded aperture prepared within the rotor; a bearing support member having a bearing for the output shaft and molded of a thermoplastic resin; and a case for housing the bearing support member and molded of a thermoplastic resin, wherein an insert nut is installed across the case and the bearing support member to be united through outsert-molding.

According to the present invention, the insert nut is installed across the case and the bearing support member to be combined integral through outsert-molding. Thus, the bonding strength between the bearing support member and the case is increased, and the fixed strength of the bearing support member is not lowered even in high temperature environments. Further, even when a load in a radial direction is imposed on the bearing section by the rotation and the vibration of the rotor, the bearing support member is not wobbled, and the resistance to vibration of the rotary motor can be increased.

### BRIEF DESCRIPTION OF THE DRAWINGS

FIG. 1 is a sectional view showing a composition of a bearing device for a rotary motor in accordance with the first embodiment of the present invention.

FIG. 2 is an enlarged view showing a fixed structure of the bearing device for a rotary motor in accordance with the first embodiment of the present invention.

FIG. 3 is a view showing a structure and an assembled state of an insert nut of the bearing device for a rotary motor in accordance with the first embodiment of the present invention.

FIG. 4 is a view showing a composition of a conventional bearing device for a rotary motor.

FIG. 5 is an enlarged view showing a fixed structure of a conventional bearing support member.

### BEST MODE FOR CARRYING OUT THE INVENTION

Embodiments of the present invention will now be described with reference to the accompanying drawings in order to explain the present invention in more detail.

### First Embodiment

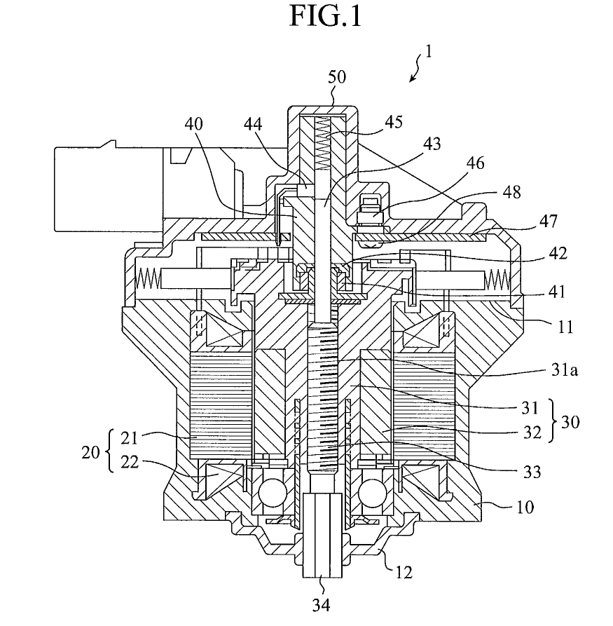

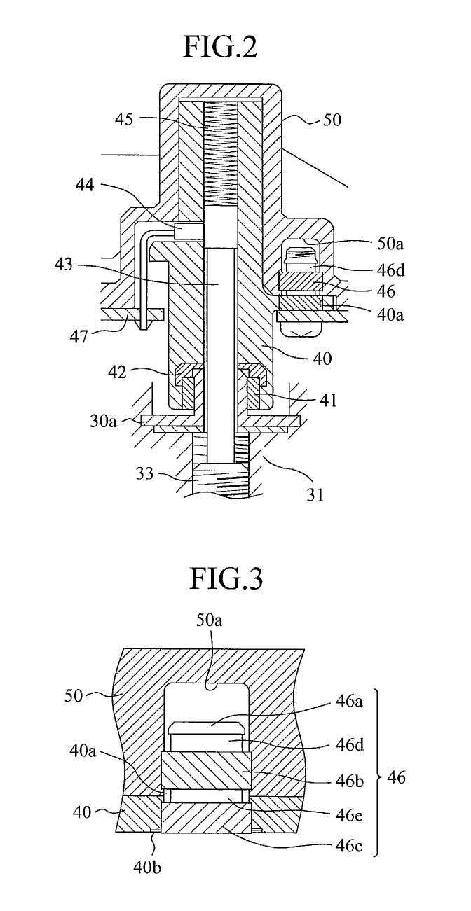

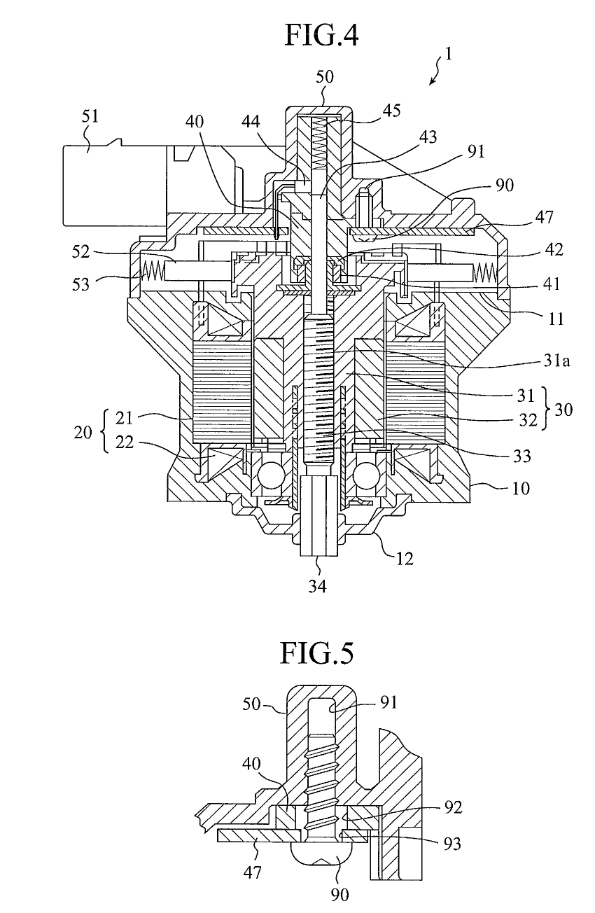

FIG. 1 is a sectional view showing a composition of a bearing device for a rotary motor in accordance with the first embodiment of the present invention, and FIG. 2 is an enlarged view showing a fixed structure of the bearing device for a rotary motor in accordance with the first embodiment of the present invention.

In the first embodiment, a bearing device for a rotary motor used for, for example, an EGR (Exhaust Gas Recirculation) valve system for constituting a recirculation system of an exhaust gas will be explained by way of example. A motor 1 that is a rotary motor works as a driving means (torque generating source) for a valve to open and close an exhaust gas passage in an EGR valve system. The motor (rotary motor) 1 includes a motor side case 10, a stator (stator) 20, a rotor (rotor) 30, a bearing support member 40, and a bearing side case (case) 50.

The motor side case 10 is a case for housing the stator 20 and the rotor 30, and is provided with an opening 11 fitting with the bearing side case 50 in one end section thereof, and a rotation-restraining means 12 of a valve shaft described later in the other end section thereof. The stator 20 includes a stator core 21 installed at a periphery of the rotor 30 and also a coil 22 disposed on both sides in an axial direction of the stator core 21. The rotor 30 is internally disposed in the stator 20, and includes a tubular rotor main body 31 secured coaxially on an outer peripheral surface of a motor shaft (output shaft) 33 and a tubular rotor magnet (magnet) 32 secured coaxially to an periphery of the rotor main body 31. The motor shaft 33 has a screw section on a peripheral surface thereof; this screw section is meshed with a threaded aperture 31a axially formed in the rotor main body 31. Further, the end of the motor shaft 33 on the valve side is equipped with grooves 34 provided at substantially equal intervals circumferentially thereof and in parallel to the axis or shaft line thereof.

The bearing support member 40 is constructed as a single unit including: a bearing 41 for supporting the shaft portion 30a of the rotor 30; a resin plate 42 provided in proximity to the bearing 41; a sensor shaft 43 provided on the upper portion of the motor shaft 33 and moving in an axial direction together with a translation or linear motion of the motor shaft 33 in the axial direction; and a position detecting sensor 44 for detecting the opening of a valve by detecting the position of the sensor shaft 43. The bearing 41 is constructed of a sliding bearing such as a tubular metal bush that is insert-molded in the bearing support member 40. The resin plate 42 is fitted over the upside of the bearing 41 in the inserting direction of the shaft 30a of the rotor 30. The shaft 30a of the rotor 30 can be extended through the bearing 41 by locking the shaft 30a of the rotor 30 with the resin plate 42. Moreover, a spring 45 for energizing the sensor shaft 43 toward the side of the motor shaft 33 is provided between the sensor shaft 43 and the bearing side case 50.

The bearing support member 40 and the bearing side case 50 each are formed of a thermoplastic resin, and an insert nut 46 formed of a metallic material is outsert-molded while being heated, so as to extend across the bearing support member and the bearing side case. Further, a board 47 to which the lead wires of the position detecting sensor 44 and so on are connected is disposed on the fixed bearing support member 40. Then the board is screwed to the insert nut 46 by a screw 48.

In the motor 1 having the above-discussed structure, upon energizing the coil 22, based on a signal from an external system through a feeder circuit (not shown) within the bearing side case 50, a magnetic field generated by that energization acts on the rotor magnet 32 to cause the rotor main body 31 to rotate. Rotation of the rotor main body 31 imposes a torque on the motor shaft 33 meshed with the threaded aperture 31a; however, since the rotation-stopping means 12 is engaged in the grooves 34 provided at the end of the motor shaft 33 on the valve side, the motor shaft 33 does not rotate, but linearly moves in the axial direction. As the motor shaft 33 rectilinearly moves in the axial direction, the opening and closing operations of a valve (not shown) are performed.

Next, the details of the structure and the assembly method of the insert nut will be described. FIG. 3 is a view showing a structure and a assembled state of the insert nut of the bearing device for a rotary motor in accordance with the first embodiment of the present invention. The insert nut 46 is formed in a generally tubular shape, has an annular tip portion 46a having a predetermined width at one end of the periphery thereof, and also has formed between the tip portion 46a and the other end of the periphery thereof, a first knurl or roulette section 46b and a second knurl section 46c, which are annular, each have a predetermined width, and are spaced by a predetermined distance from each other. Further, annular grooves 46d and 46e having a predetermined width are formed between the tip portion 46a and first knurl section 46b, and between the first knurl section 46b and second knurl section 46c, respectively.

In the first knurl section 46b and second knurl section 46c, a plurality of knurls extending in an inclined direction with respect to the axial direction of the insert nut 46 are formed over the entire periphery thereof. The knurls in the first knurl section 46b and the ones in the second knurl section 46c are formed so as to extend in a different direction from each other, that is, in a radial direction from the groove 46e as a center. It is possible to firmly bond the insert nut 46 to the bearing side case 50 and bearing support member 40 by providing the insert nut 46 with the first knurl section 46b and second knurl section 46c. Furthermore, by forming the knurls of the first knurl section 46b and the ones of the second knurl section 46c such that they extend in a different direction from each other, the insert nut 46 cannot be rotated even when a torque is imposed on the insert nut in either of right and left directions; thus, the insert nut can be prevented from being dropped out of the bearing support member 40 and the bearing side case 50.

The bearing support member 40 has a hole 40a, while the bearing side case 50 has a cavity 50a. The internal diameters of the hole 40a and cavity 50a are arranged smaller than the outer diameter of the insert nut 46. The insert nut 46 is inserted into the hole 40a and cavity 50a while being heated with a soldering iron or the like. The heat transmitted from the soldering iron to the insert nut 46 can melt the bearing side case 50 and bearing support member 40 formed of a thermoplastic resin. The resin melted around the insert nut 46 can be flowed into the spaces between the knurls formed in the first knurl section 46b and second knurl section 46c of the insert nut 46, and the grooves 46d and 46e.

When the heating of the insert nut 46 is stopped and then the bearing side case 50 and bearing support member 40 are cooled down to the heat distortion temperature of the resin or less, the resin flowed into the spaces between the knurls of the first knurl section 46b and second knurl section 46c, and the grooves 46d and 46e of the insert nut 46 can be adhered to the surroundings thereof, and the insert nut 46 is integrally fixed with the bearing side case and bearing support member in a state installed across the hole 40a and cavity 50a. The inner peripheral surface of the insert nut 46 is screw-threaded; thus, the board 47 can be disposed on the outsert-molded bearing support member 40 to be screwed by the screw 48. In such a way, by outsert-molding the insert nut 46 to the bearing support member 40 and bearing side case 50, the bearing side case 50 and bearing support member 40 can be integrally secured to each other, and also the board 47 can be screwed and fixed by using the insert nut 46.

Moreover, the edge of the hole 40a in the outer surface of the bearing support member 40 contacting the board 47 is provided with a circumferential counterbored groove 40b, and thus an surplus resin melted during the assembly can be escaped to the counterbored groove 40b. The flow of the resin is restricted; thus, it is possible to restrain the resin solidified after melting from protruding from the outer surface of the bearing support member 40 and the end face of the second knurl section 46c of the insert nut 46.

In this context, the tip temperature of the soldering iron for heating the insert nut 46 is preferably about 320° C., and when the temperature thereof exceeds 350° C., the resins forming the bearing side case 50 and bearing support member 40 can be damaged. The temperature on the heating can be appropriately adjusted depending on the type of the thermoplastic resin forming the bearing side case 50 and bearing support member 40. On the other hand, for an outsert-molding method, it is contemplated to insert the insert nut 46 thereinto while slightly vibrating the insert nut by ultrasonic wave; however, since a built-in position detecting sensor 44 can be damaged by vibration, a thermally outsert-molding method is employed in the present invention. Another outsert-molding method that cannot damage the built-in sensor and so on can be appropriately modified as an alternative.

As discussed above, in accordance with the first embodiment, the insert nut is outsert-molded so as to be installed across the bearing support member and bearing side case; thereby, the bearing support member, bearing side case, and insert nut are arranged to be united. Thus, the combining strength between the bearing support member and bearing side case can be improved. In this way, the combination between the bearing support member and bearing side case cannot be loosened even in high temperature environments, and further, even when a load in a radial direction is imposed on the bearing by the rotation and/or vibration of the rotor, the bearing support member cannot be wobbled. Thus, the resistance to vibration of the rotary motor can be increased. Moreover, since the bearing support member is restrained from wobbling, it becomes possible to attach the position detecting sensor to the bearing support member to thus integrate those components into a single unit. In this way, the size of the motor shaft in the axial direction can be reduced, and also assembling steps thereof can be reduced.

Furthermore, in accordance with the first embodiment, the inner peripheral surface of the insert nut is screw-threaded, and thus the board can be fixed on the bearing support member by a screw using the insert nut.

Moreover, in accordance with the first embodiment, it is arranged that the bearing support member have a circumferential counterbored groove around the edge of the hole to be inserted by the insert nut in the outer surface thereof. Thus, the resin melted in the case where the insert nut is thermally outsert-molded can be prevented from protruding from the end face of the insert nut and adhering thereto, and the seat of the board to be disposed on the bearing support member can be stabilized.

In addition, in accordance with the first embodiment, it is arranged that the knurls provided in the knurl sections of the insert nut is provided in an inclined direction with respect to the axial direction of the insert nut, and thus the insert nut is strongly fixed to the bearing support member and bearing side case.

Besides, in accordance with the first embodiment, it is arranged that the knurls provided in the first knurl section and second knurl section extend in a different direction from each other. Thus, the insert nut is not rotated even when a torque is imposed on the insert nut in either of right and left directions, and the insert nut can be prevented from dropping out of the bearing support member and bearing side case.

Further, in accordance with the first embodiment, the position detecting sensor is attached to the bearing support member to integrate those components into a single unit, and thereby it is possible to reduce the number of components and also simplify the assembly process thereof.

Additionally, in accordance with the first embodiment, it is arranged that the insert nut is outsert-molded while being heated. Thus, the insert nut can be outsert-molded without vibrating the surroundings of the position detecting sensor, and the position detecting sensor is not damaged.

### INDUSTRIAL APPLICABILITY

As discussed above, according to the bearing device for a rotary motor of the present invention, it is arranged that the insert nut is united by outsert-molding to be installed across the case and bearing support member. Thus, the combining strength between the bearing support member and case can be increased, and the securing strength of the bearing support member cannot be reduced even in high temperature environments. Further, even when a load in a radial direction is imposed on the bearing section by the rotation and/or the vibration of the rotor, the bearing support member cannot be wobbled, and the resistance to vibration of the rotary motor can be improved. Therefore, the bearing device is suitable for use in the bearing device and the like for a rotary motor to be employed in an EGR valve system.

1. A bearing device for a rotary motor including:
a stator having provided thereon a coil to which a current is fed;
a rotor rotating the inside of the stator and having a magnet;
an output shaft having provided thereon a screw portion meshing with a threaded aperture prepared within the rotor;
a bearing support member having a bearing for the output shaft and molded of a thermoplastic resin; and
a case for housing the bearing support member and molded of a thermoplastic resin,
wherein an insert nut is installed across the case and bearing support member to be united through outsert-molding.

2. The bearing device for a rotary motor according to claim 1, wherein the insert nut has internal or external threads on the inner peripheral surface thereof.

3. The bearing device for a rotary motor according to claim 1, wherein the bearing support member has a counterbored groove at the edge of a hole to be inserted therein by the insert nut.

4. The bearing device for a rotary motor according to claim 1, wherein the insert nut has knurls extending in an inclined direction with respect to the inserting direction thereof.

5. The bearing device for a rotary motor according to claim 4, wherein the insert nut has a first knurl section located on the side of the bearing support member and a second knurl section located on the side of the case when the outsert-molding is completed, and knurls formed in the first knurl section and knurls formed in the second knurl section are inclined in a different direction from each other.

6. The bearing device for a rotary motor according to claim 1, further comprising a position detecting sensor for detecting the position of the output shaft in the axial direction, wherein the position detecting sensor is integrally fixed to the bearing support member.

7. The bearing device for a rotary motor according to claim 6, wherein the outsert-molding is performed by heating the insert nut to melt the thermoplastic resins forming the case and the bearing support member, and press-fitting the insert nut into the case and bearing support member.
